(19) United States
(12) Patent Application Publication
(10) Pub. No.: US 2008/0063782 A1
(43) Pub. Date: Mar. 13, 2008

(54) Zero-trans fat shortening for laminated dough applications

(75) Inventors: Tim Cottrell, Hoffman Estates, IL (US); Peggy Dantuma, Hoffman Estates, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Kerry Group Services International, Ltd., County Kerry (IE)

(21) Appl. No.: 11/520,822

(22) Filed: Sep. 13, 2006

(51) Int. Cl. A23D 9/00

(52) U.S. Cl. 426/607

(57) ABSTRACT

The present invention provides a shortening composition free of trans fatty acids and comprises at least one partially acetylated monoglyceride, at least one fully acetylated monoglyceride, at least one mixed mono-diglyceride, and at least one vegetable oil. The shortening composition of the present invention optionally comprises at least one vegetable hard stock and optionally comprises one or more antioxidants. Further, in some embodiments the shortening composition is anhydrous. The zero trans fat shortening composition of the present invention is characterized by excellent plasticity and elasticity, and is useful for the preparation of fine baking goods.

### FIELD OF THE INVENTION

The present invention relates to a shortening composition, more particularly, to a shortening composition free of zero trans fat which provides good plasticity and extensibility.

### BACKGROUND OF THE INVENTION

Laminated doughs are the foundation for several fine bakery goods including, for example, danish, croissants, napoleons, and the like. The lamination process involves alternating many layers of sweet dough and shortening to prepare a multi-layered dough that will result in a flaky layered product following baking. The shortening required for lamination needs to be sufficiently extensible and plastic to machine between the dough layers without tearing the dough. Plasticity is a characteristic wherein the dough, once deformed, for example by kneading, retains its shape. Plasticity is important for laminated doughs because it helps keep the layers of dough separate. In conventional laminated doughs, the use of hydrogenated oils results in desirable plasticity, but also high concentrations of trans fats. The trans fats present in traditional shortenings confer good plasticity and elasticity to the dough.

Shortenings are a source of fat in baking applications, and can be described as a functional plastic solid fat prepared by carefully cooling, plasticizing, and tempering a blend of molten fats and oil. Conventional shortenings often comprise partially hydrogenated vegetable oils, for example, partially hydrogenated soybean oil, canola oil, sunflower seed oil, and the like. These oils are popular because they can be obtained inexpensively in large quantities and, through hydrogenation of the oils, can be used to produce a variety of fats with different properties depending on desired properties of the finished product. Unfortunately, a byproduct of the hydrogenation process is the production of trans fatty acids, such that, a percentage of the cis double bonds present in the fatty acids isomerize to the trans stereoisomer.

For example, a typical conventional shortening employed in baking applications may contain 15-35% of trans fatty acids. Although the use of trans fats in conventional shortenings imparts useful properties in baking applications, the use of trans fatty acids has recently been subject to scrutiny by nutritional science. For example, there have been clinical studies reporting observed negative health effects correlated to the presence of trans fatty acids formed during the partial hydrogenation of oils, e.g., a positive correlation with coronary heart diseases an increase in the ratio of plasma low density lipoproteins (LDL) to high density lipoproteins (HDL) and thus a possible increase in the risk of coronary heart disease. See, for example, Schaefer, E. J. Am J. Clin. Nutr. 2002, 75, 191-212. Thus, recently the trend in processed foods, and in the bakery goods in particular is to avoid the use of trans fats for health concerns. Heretofore attempts to make fine bakery products with shortenings that are free of trans fats have not been satisfactory. Trans fat free shortenings tend to tear the dough during processing, thereby resulting in a poor finished product.

Accordingly, lowering trans fatty acids in foods is a desirable goal. Despite the longstanding efforts of those skilled in the art to provide a trans fat free shortening composition, there remains a need for a shortening composition free of trans fatty acids and a process for making trans fatty acids free shortenings. In addition, there remains a need for a laminated dough, wherein the laminated dough is free of trans fatty acids. Further, there remains a need for a baked good, wherein the baked good is free of trans fatty acids.

The present invention provides a shortening composition free of trans fatty acids with extensibility and plasticity such that the product can be used at remarkably low levels with excellent results.

### BRIEF SUMMARY OF THE INVENTION

The present invention provides a shortening composition free of trans fatty acids and comprises at least one partially acetylated monoglyceride, at least one fully acetylated monoglyceride, at least one mixed mono-diglyceride, and at least one vegetable oil. The shortening composition of the present invention optionally comprises at least one vegetable hard stock and optionally comprises one or more antioxidants. Further, in some embodiments the shortening composition is anhydrous. The zero trans fat shortening composition of the present invention is characterized by excellent plasticity and elasticity, and is useful for the preparation of fine baking goods.

### DETAILED DESCRIPTION OF THE INVENTION

The present invention provides a shortening composition free of trans fatty acids comprising at least one partially acetylated monoglyceride, at least one fully acetylated monoglyceride, at least one mixed mono-diglyceride, and at least one vegetable oil. The trans fatty acid-free shortening composition of the present invention optionally comprises at least one vegetable hard stock and optionally comprises one or more antioxidants. Further, in some embodiments the shortening composition is anhydrous. The shortening compositions described herein are suitable for use in food products, especially in baked goods prepared from laminated doughs, for example, in napoleons, danish, croissants, and the like.

As understood in the art and as used herein, the terms “zero trans”, “low trans”, “fatty acids”, “free of trans” refers to little or no trans fat being present in a product. For example, according to the FDA, food products containing less than 0.5 g of trans fat per serving are considered to be “zero” trans fat foods. See, for example, Federal Register, Vol. 68, No. 133, pp. 41433-41506.

The shortening compositions of the present invention preferably comprise blends of emulsifiers or surfactants, fats, and oils. The various components of the composition desirably are selected to impart different properties to the composition. In the preferred embodiment of the invention, trans fatty acid-free shortening compositions of the present invention are homogeneous. The shortening composition does not weep oil and is characterized by excellent plasticity and extensibility. Not wishing to be bound by any particular theory, it is believed that the increased plasticity of shortening compositions of the present invention results from the fibrous network of trapped fat crystals thereby contributing to increased plasticity.

The acetylated glycerides function as an emulsifier or surfactant helping to provide for a homogenous composition while imparting specific attributes to the composition. In particular, the partially acetylated monoglycerides provide plasticity and film-forming properties to shortening compositions of the present invention and contribute to the firmness of the compositions. The fully acetylated monoglycerides function as plasticizers, increasing extensibility which increase the softness or flexibility of the inventive compositions. The mixed mono-diglyceride component serves as a crystal modifier and a nucleation site for crystallization and also contributes to the firmness of the composition. Vegetable oils are included to provide the bulk texture or matrix of the compositions and generally act as the fat continuous phase. Vegetable hard stocks, if included, impart stiffness to the compositions. Antioxidants, if included, serve to stabilize the compositions from oxidative degradation. Other surfactants, for example, lecithin, can be included in the shortening compositions of the present invention.

As understood in the art and as used herein, the term “shortening” refers to a fat product that is plastic at room temperature. Illustrative solid fats suitable for use in forming the shortening composition of the present invention include, but are not limited to, partially acetylated monoglycerides, mixed mono- and diglycerides, vegetable hard stock, and mixtures thereof. Exemplary liquid fats include, but are not limited to, fully acetylated monoglycerides, vegetable oils, and mixtures thereof.

As understood in the art and as used herein, the term “glyceride” refers to ester compounds formed by reacting glycerol with fatty acids, and includes mono-, di-, and tri-fatty acid esters of glycerol. As used herein, the term “monoglyceride” refers to a glyceride characterized by having one fatty acid esterifed to glycerol and two unreacted hydroxyl groups. Similarly, the term “diglyceride” refers to glycerides with two fatty acid ester linkages and one unreacted hydroxyl group. In the case of diglycerides, the fatty acid portion of the molecules may be the same or different. Suitable fatty acids for esterification with glycerol are well known in the art and include saturated, monounsaturated, and polyunsaturated fatty acids. Illustrative fatty acids include, for example, C₁₆₋₂₀ fatty acids such as linoleic, myristic, oleic, palmitic, stearic acid, and mixtures of these fatty acids in all proportions. Preferred fatty acids include, for example, C₁₆₋₁₈ fatty acids.

As understood in the art and as used herein, the term “acetylated monoglyceride” refers to compounds consisting of glycerol esterified with fatty acids at one of the three hydroxyl groups, with the other two remaining hydroxyl groups esterified with acetyl moieties. Similarly, “acetylated diglycerides” are characterized by two fatty acid acyl moieties, which may or may not be the same, and one acetate ester moiety.

The degree of acetylation and unsaturation contribute to the compounds suitable for use in the present invention. As used herein, the term “fully acetylated” refers to a degree of acetylation which is at least 96%. The term “partially acetylated” refers to a degree of acetylation which is less than about 96%. By varying the amount of unsaturation of the fatty acid portion of the mono- and diglyceride and the degree of acetylation, different properties can be obtained. For example, fully acetylated monoglycerides prepared from unsaturated monoglycerides are liquids at room temperature, while partially acetylated monoglycerides prepared from vegetable stearine are solid at room temperature.

Illustrative examples of glycerides and acetylated glycerides include, but are not limited to, glycerides and acetylated glycerides available from Kerry Bio-Science under the trademarks Myvacet®, Admul®, and Myverol®. For example, Myvacet® 9-35K is an acetic acid ester of distilled mono-diglycerides based upon vegetable feedstocks. Myvacet® 9-35K is provided as a clear liquid derived from palm oil containing 0.22% citric acid and 0.16% ascorbic acid as additives, and has the following properties: hydroxyl value of 0-15; saponification value of 380-395 mg KOH/g; maximum acid value of 3 mg KOH/g; iodine value of 23-33 g L/100 g; minimum degree of acetylation of 96%; and a melting point of 13-17° C.

Myvacet® 5-07K is an acetic acid ester of mono-diglycerides based upon vegetable feedstocks. Myvacet® 5-07K is provided as a pale yellow, waxy solid derived from vegetable stearine containing 0.02% citric acid as an additive, and has the following properties: hydroxyl value 133-152; saponification value 279-292 mg KOH/g; maximum acid value 3 mg KOH/g; maximum iodine value 5 g L/100 g; degree of acetylation of 50%; and a melting point of 46° C.

Myvacet® 7-07K is an acetic acid ester of distilled mono-diglycerides based upon vegetable feedstocks. Myvacet® 7-07K is provided as a pale yellow, waxy solid derived from vegetable stearine containing 0.02% citric acid as an additive, and has the following properties: hydroxyl value 80-95; saponification value of 316-331 mg KOH/g; maximum acid value of 3 mg KOH/g; maximum iodine value of 3 g L/100 g; degree of acetylation of 68%; and a melting point of 40° C.

Admul® MG 40-04K is a mono-diglyceride prepared from vegetable oils and fats. Admul® MG 40-04K is provided as a white bead derived from palm oil and has the following properties: total monoglycerides of 45%; maximum free glycerol content of 1.5%; maximum acid value of 3 mg KOH/g; and maximum iodine value of 3 g L/100 g.

Myverol® 18-06K is a distilled monoglyceride prepared from vegetable oils and fats, is derived from soya feedstock, and has the following properties: total monoglycerides content of 93%; maximum free glycerol content of 1%; maximum acid value of 3 mg KOH/g; maxium iodine value of 3 g L/100 g; and a melting point of 69° C.

In accordance with the invention, the shortening composition includes from about 5-70% by weight of at least one partially acetylated monoglyceride. More preferably, the shortening composition comprises from about 10-65%, 15-60%, 20-55%, 25-55%, 30-55%, 35-55%, 40-55%, and 45-55% by weight of at least one partially acetylated monoglyceride. Most preferably, the shortening composition comprises about 50% by weight of at least one partially acetylated monoglyceride.

The shortening compositions of the present invention include from about 2-30% by weight of at least one fully acetylated monoglyceride. Preferably, the shortening composition of the present invention comprises from about 2-25%, 5-25%, 10-25%, and 15-20% by weight of at least one fully acetylated monoglyceride. More preferably, the shortening composition comprises from about 15-20% by weight of at least one fully acetylated monoglyceride. More preferably, the shortening composition comprises about 15% by weight of at least one fully acetylated monoglyceride. In a most preferred embodiment, the shortening composition comprises about 15.5% by weight of at least one fully acetylated monoglyceride.

The shortening compositions of the present invention include from about 2-30% by weight of at least one mixed mono-diglyceride. In a preferred embodiment, the present invention comprises up to about 2-25%, 2-20%, 2-15%, and 2-10% by weight of a mixed mono-diglyceride. More preferred, the shortening composition of the present invention comprises up to about 2-5% by weight of a mixed mono-diglyceride. More preferred still, the present invention comprises up to about 2-3% by weight of a mixed mono-diglyceride. In a most preferred embodiment, the present invention comprises about 2% by weight of a mixed mono-diglyceride.

Illustrative of vegetable oils which can be used in the shortening compositions of the present invention include, without limitation, canola oil, cottonseed oil, sunflower oil, safflower oil, corn oil, palm oil, soybean oil, and mixtures thereof. Preferred vegetable oils to be used in the present invention include canola oil and cottonseed oil and mixtures thereof. A preferred vegetable oil is canola oil available from Kerry BioScience having the following properties: maximum acid number of 0.2 mg KOH/g; Sap number between 182 and 192 mg KOH/g; Iod number between 105 and 126; and a maximum water content of 0.1%. Shortening compositions of the present invention include from about 15-90% by weight of at least one vegetable oil. In preferred embodiments, shortening compositions of the present invention comprise from about 15-80%, 15-70%, 15-60%, 15-50%, 15-40%, 15-30%, and 20-25% by weight of at least one vegetable oil. More preferably, the present invention comprises about 22% of at least one vegetable oil. Most preferably, the shortening composition comprises about 22.5% of at least one vegetable oil.

Illustrative vegetable hard stocks which can be used in the present invention include, without limitation, fractionated vegetable stocks and fully hydrogenated vegetable oils. Preferred vegetable hard stocks include, but are not limited to, stearine, fully hydrogenated cottonseed oil, fully hydrogenated palm oil, and fully hydrogenated canola oil. Most preferred vegetable hard stocks for use in the present invention are palm stearine and fully hydrogenated cottonseed oil. A preferred vegetable hard stock is fractionated palm oil available from Kerry BioScience having the following properties: maximum acid number of 0.1 mg KOH/g; maximum free fatty acid number of 0.05%; maximum perioxide value of 1.0 mg/g; maximum trans fatty acid content of less than 1%; a iodine of value of approximately 14 mg/100 g; and a melting point of 60° C. In preferred embodiments, shortening compositions of the present invention comprise from about 2-15% by weight of a vegetable hard stock. In more preferred embodiments, the shortening compositions comprise from about 5-10% by weight of a vegetable hardstock. More preferably, the present invention comprises about 10% by weight of a vegetable hard stock.

The compositions of the present invention may optionally comprise an antioxidant. Suitable antioxidants for use in the shortening compositions of the present invention include butylated hydroxyanisole, citric acid, ascorbic acid, and the like.

The shortening compositions of the present invention can include various components known to those of ordinary skill in the art to be useful in the preparation of dough. For example, compositions in accordance with the present invention include artificial flavorings, emulsifiers, structured fats, fat crystal modifiers, food grade enzymes, hydrolyzed petides, no trans shortenings, and combinations thereof, as well as other components depending on the application and desired properties. One skilled in the art will recognize that these additional components are included depending on the desired result and do not limit the scope of the invention.

By way of illustration, and not in limitation, shortening compositions of the present invention, in some embodiments, include butter flavoring. An illustrative butter flavoring comprises water, glycerol, invert sugar, and artificial flavors. Some embodiments of the present invention include lecithin. An illustrative lecithin is Lecithin FT from Cargill, which is suitable for use as an emulsifier, wetting agent, stabilizer, instantizing agent, release agent, lubricant, antioxidant, and dispersant. Some embodiments of the present invention include a structured fat. An illustrative structured fat is Revel® A from Loders Croklaan. Revel® A is a fractionated, non-hydrogentated, refined vegetable fat of non-lauric origin derived from palm oil. Revel® A has the following properties: melting point of 88° C.; iodine value of 14; free fatty acid content of 0.05%; maximum peroxide value of 1.0; and a trans fatty acid content of less than 1%. Some embodiments of the present invention include a fat crystal modifier. An illustrative fat crystal modifier is Admul® S-65K from Kerry BioScience, which is a sorbitan tri-stearate provided as a tan, waxy bead with the following physical properties: hydroxyl value 66-80 mg KOH/g; saponification value 176-188 mg KOH/g; maximum acid value 15 mg KOH/g; and a maximum water content (K.F.) of 1%.

Some embodiments of the present invention comprise food grade enzymes. A preferred food grade enzyme is Biobake® SLP from Kerry Bio-Science. Biobake® SLP is a is a complex fungal α-amylase system derived from Aspergillus which facilitates improved crumb textures and increased machineability. Biobake® SLP is active between 44-65° C. and a pH range of 4.5-7.0. Some embodiments of the present invention include hydrolyzed wheat peptides to, for example, decrease dough kneading time, to increase dough flexibility during processing, and to produce high fiber flour mixes. An illustrative hydrolyzed wheat peptide is Dorel® 8354 from Kerry BioScience, which is provided as powder with the following properties: minimum protein content of 65%; maximum moisture content of 6%; and a maximum ash content of 4%.

Some embodiments of the present invention comprise no trans shortenings. An illustrative no trans shortening is Myvatex® Sweet NT K, available from Kerry BioScience, which is particularly useful as a fat source for doughs. For example, in cookies, its use results in no trans cookies with good spread and eating quality. Myvatex® Sweet NT K is a blend of canola, palm oil, mono-and diglycerides, diacetyl tartaric acid esters of monoglycerides and sodium stearoyl lactylate and contains citric acid and ascorbic acid as additives. Another illustrative no trans shortening is SansTrans® 39 available from the 101 group. SansTrans® 39 is a bakery shortening based on palm oil and fractions of palm oil with the following properties: Mettler Dropping Point of 40° C.; maximum free fatty acid content of 0.05%; maximum peroxide value of 1.0; and a iodine value of 51-53.

One skilled in the art will recognize that the combination of ingredients can be varied to modify the properties according to the desired application such that a zero trans fatty acid shortening composition with suitable plasticity and extensibility is obtained.

Shortening compositions of the present invention are prepared using a blend of emulsifiers or surfactants, fats, and oils to obtain a homogenous composition. The shortening compositions of the present invention can be made by forming a mixture of at least one partially acetylated monoglyceride, at least one fully acetylated monoglyceride, at least one mixed mono-diglyceride, at least one vegetable oil, and at least one vegetable hard stock, if it is included, with stirring for a period of time sufficient to obtain a clear homogenous melt using, for example, a scraped surface heat exchanger. The melt is cooled under shear for a period of time to obtain a partially solidified mixture using, for example, a votator. During cooling, a “spike” in the temperature, associated with the heat of crystallization, is often observed. The partially solidified mixture is kneaded for a period of time sufficient to obtain a smooth homogenous mixture which has a shiny appearance. As one skilled in the art will recognize, the shiny appearance of the product obtained after kneading is indicative of an ideal crystal structure. After cooling, the product can be packaged and stored for an additional period of time to further crystallize. The additional storage time is typically 24 hours and can be conducted at room temperature or refrigerated temperatures. In preferred embodiments, at least one vegetable hard stock and/or antioxidant is included with the mixture of partially acetylated monoglyceride, fully acetylated monoglyceride, mixed mono-diglyceride, and vegetable oil.

Laminated doughs of the present invention comprise relatively higher levels of acetylated monoglycerides as compared to traditional laminated doughs. Increased levels of acetylated products impart improved moisture barrier properties to compositions of the present invention. In particular, compositions of the present invention are more resistant to migration of moisture from one layer to another. In cooking applications, this results in improved leavening properties of the dough. In baked goods made with the shortening composition of the present invention, the goods are less prone to become soggy when containing a moist filling.

In accordance with the present invention, the laminated doughs comprise the zero trans fatty acid shortening of the present invention. In a preferred embodiment, laminated doughs of the present invention comprise from about 6-30% by weight of the shortening composition.

In other embodiments, the present invention provides baked goods prepared from a laminated dough comprising the zero trans fatty acid shortening of the present invention. In preferred embodiments, baked goods of the present invention are selected from the group consisting of danish, napoleon, and croissant. More preferred the baked good is a danish. Also, preferred embodiments include napoleon. Further preferred embodiments are croissants.

The following examples further illustrate the invention but, of course, should not be construed as in any way limiting its scope.

The shortening compositions of the Examples 1-19 were prepared using the following general process. Modifications to the general process were performed as indicated.

A mixture of the components was formed and the mixture was heated together at a temperature sufficient to form a clear homogeneous melt under mixing conditions using a scraped surface heat exchanger, followed by cooling the melt to approximately 4° C. under shear using a votator to obtain a partially solidified mixture. The mixture is kneaded for a period of time to obtain a smooth homogeneous mixture which has a shiny appearance. Cooling nucleates the fat crystals resulting in a smooth, homogeneous shiny appearance as the ideal crystal structure is obtained. The finished product is packaged directly from the votator and allowed to set-up and cool further at ambient temperature for 24 hours before using. The finished product has the following characteristics: good plasticity, extensible without breaking, free of trans fatty acids, low in saturated fatty acids, SFI curve similar to traditional roll-in shortenings, bland clean flavor, and improved moisture barrier properties.

### EXAMPLE 1

This example illustrates an embodiment of a shortening composition in accordance with the present invention, wherein the shortening composition comprises acetylated monoglycerides, vegetable oil, vegetable hard stock, and monoglycerides and prepared using the general process parameters described above. Water was added at 75° C. The blend was mixed with a scraped surface heat exchanger and cooled to 4° C. over approximately 15 minutes. The product shortening had a varied texture.

TABLE 1

| Ingredient | Amount (weight %) |
|---|---|
| Canola oil | 64.5 |
| Fully hydrogenated cottonseed oil | 13 |
| Admul ® MG 40-04K | 7 |
| Myvacet ® 5-07K | 5 |
| Lecithin | 0.5 |
| Water | 10 |

### EXAMPLE 2

This example illustrates an embodiment of a shortening composition of the present invention, wherein the shortening composition comprises acetylated monoglycerides, vegetable oil, vegetable hard stock, and monoglycerides and prepared using the general process parameters described above. The blend was melted together at about 74° C. and mixed. The product shortening had a soft smooth texture.

TABLE 2

| Ingredient | Amount (weight %) |
|---|---|
| Canola oil | 74.7 |
| Fully hydrogenated cottonseed oil | 7 |
| Admul ® MG 40-04K | 4 |
| Myvacet ® 5-07K | 14 |
| Admul ® S 65K | 0.3 |

### EXAMPLE 3

This example illustrates an embodiment of a shortening composition of the present invention, wherein the shortening composition comprises acetylated monoglycerides, vegetable oil, vegetable hard stock, and monoglycerides and prepared using the general process parameters described above. The product shortening had a soft texture.

TABLE 3

| Ingredient | Amount (weight %) |
|---|---|
| Canola oil | 69.7 |
| Palm stearine | 5 |
| Fully hydrogenated cottonseed oil | 7 |
| Admul MG 40-04K | 4 |
| Myvacet ® 5-07K | 14 |
| Admul ® S 65K | 0.3 |

### EXAMPLE 4

This example illustrates an embodiment of a shortening composition of the present invention, wherein the shortening composition comprises acetylated monoglycerides, vegetable oil, vegetable hard stock, and monoglycerides and prepared using the general process parameters described above.

TABLE 4

| Ingredient | Amount (weight %) |
|---|---|
| Canola oil | 65.7 |
| Fully hydrogenated cottonseed oil | 13 |
| Admul ® MG 40-04K | 7 |
| Myvacet ® 5-07K | 7 |
| Myvacet ® 7-07K | 7 |
| Admul ® S 65K | 0.3 |

### EXAMPLE 5

This example illustrates an embodiment of a shortening composition of the present invention, wherein the shortening composition comprises acetylated monoglycerides, vegetable oil, vegetable hard stock, and monoglycerides. Water was added at 75° C. after the other components had been melted together. The mixture was cooled to about 32° C. using alternating cooling cycles of 15 seconds. An increase in temperature to 35° C. was observed during cooling. The product shortening had a soft texture.

TABLE 5

| Ingredient | Amount (weight %) |
|---|---|
| Canola oil | 64.4 |
| Palm stearine | 5 |
| Fully hydrogenated cottonseed oil | 7 |
| Admul ® MG 40-04K | 4 |
| Myvacet ® 5-07K | 14 |
| Admul ® S 65K | 0.3 |
| Lecithin | 0.3 |
| Water | 5 |

### EXAMPLE 6

This example illustrates an embodiment of a shortening composition of the present invention, wherein the shortening composition comprises acetylated monoglycerides, vegetable oil, vegetable hard stock, and monoglycerides. The water phase was prepared by heating the water, phosphoric acid and lecithin with mixing to 75° C. The water phase was added to the fat phase with agitation at 75° C. The mixture was cooled to about 32° C. using alternating cooling cycles of 15 seconds. The product shortening had a soft texture.

TABLE 6

| Ingredient | Amount (weight %) |
|---|---|
| Canola oil | 58.9 |
| Palm stearine | 5 |
| Fully hydrogenated cottonseed oil | 7 |
| Admul ® MG 40-04K | 4 |
| Myvacet ® 5-07K | 14 |
| Admul ® S 65K | 0.3 |
| Lecithin | 0.5 |
| Phosphoric Acid | 0.3 |
| Water | 10 |

### EXAMPLE 7

This example illustrates an embodiment of a shortening composition of the present invention, wherein the shortening composition comprises acetylated monoglycerides, vegetable oil, vegetable hard stock, and monoglycerides. The mixture was cooled to about 42° C. An increase in temperature rise to 43° C. was observed during cooling. The product shortening had a soft smooth texture.

TABLE 7

| Ingredient | Amount (weight %) |
|---|---|
| Canola oil | 65 |
| Fully hydrogenated cottonseed oil | 3.25 |
| Admul ® MG 40-04K | 1.75 |
| Myvacet ® 5-07K | 30 |

### EXAMPLE 8

This example illustrates an embodiment of a shortening composition of the present invention, wherein the shortening composition comprises acetylated monoglycerides, vegetable oil, vegetable hard stock, and monoglycerides. The ingredients were heated to 75° C. with stirring for 10 minutes and then cooled to about 41° C. using alternate cooling cycles with 15 second intervals. The product shortening had a soft slightly crumbly texture.

TABLE 8

| Ingredient | Amount (weight %) |
|---|---|
| Canola oil | 55 |
| Fully hydrogenated cottonseed oil | 3.25 |
| Admul ® MG 40-04K | 1.75 |
| Myvacet ® 5-07K | 40 |

### EXAMPLE 9

This example illustrates an embodiment of a shortening composition of the present invention, wherein the shortening composition comprises acetylated monoglycerides, vegetable oil, vegetable hard stock, and monoglycerides. The ingredients were heated to 75° C. with stirring for 15 minutes and then cooled to about 32° C. using alternate cooling cycles. The product shortening had a soft crumbly texture.

TABLE 9

| Ingredient | Amount (weight %) |
|---|---|
| Canola oil | 27 |
| Fully hydrogenated cottonseed oil | 3.25 |
| Admul ® MG 40-04K | 1.75 |
| Myvacet ® 5-07K | 40 |
| Sans trans 39 | 28 |

### EXAMPLE 10

This example illustrates an embodiment of a shortening composition of the present invention, wherein the shortening composition comprises acetylated monoglycerides, vegetable oil, vegetable hard stock, and monoglycerides. The ingredients were melted together and cooled to about 32° C. in a scraped surface heat exchanger. The product shortening had a hard crumbly texture.

TABLE 10

| Ingredient | Amount (weight %) |
|---|---|
| Canola oil | 9.72 |
| Fully hydrogenated cottonseed oil | 4.51 |
| Admul ® MG 40-04K | 2.44 |
| Myvacet ® 5-07K | 83.33 |

### EXAMPLE 11

This example illustrates an embodiment of a shortening composition of the present invention, wherein the shortening composition comprises acetylated monoglycerides, vegetable oil, vegetable hard stock, and monoglycerides. The ingredients were melted together at about 75° C. with mixing for 15 minutes. The mixture was allowed to cool to about 57° C. and then transferred to a scraped surface heat exchanger and allowed to cool to about 32° C. with constant scraping of the bowl. The mixture was then blended further using a high shear immersion blender. An increase in temperature to 35° C. was observed during cooling. The product shortening had a soft smooth texture.

TABLE 11

| Ingredient | Amount (weight %) |
|---|---|
| Canola oil | 24.11 |
| Fully hydrogenated cottonseed oil | 2.9 |
| Admul ® MG 40-04K | 1.56 |
| Myvacet ® 5-07K | 53.57 |
| Myvacet ® 9-35 | 17.86 |

### EXAMPLE 12

This example illustrates an embodiment of a shortening composition of the present invention, wherein the shortening composition comprises acetylated monoglycerides, vegetable oil, vegetable hard stock, and monoglycerides. The ingredients were melted together at about 75° C. with mixing for 15 minutes. The mixture was allowed to cool to about 57° C. and then transferred to a scraped surface heat exchanger and allowed to cool to about 32° C. with constant scraping of the bowl. An increase in temperature to 41° C. was observed during cooling. The mixture was then blended further using a high shear immersion blender and packed off at 35° C. The product shortening had a smooth spreadable texture.

TABLE 12

| Ingredient | Amount (weight %) |
|---|---|
| Canola oil | 22.5 |
| Fully hydrogenated cottonseed oil | 3.25 |
| Admul ® MG 40-04K | 1.75 |
| Myvacet ® 5-07K | 50 |
| Myvacet ® 9-35 | 22.5 |

### EXAMPLE 13

This example illustrates an embodiment of a shortening composition of the present invention, wherein the shortening composition comprises acetylated monoglycerides, vegetable oil, vegetable hard stock, and monoglycerides. The ingredients were melted together at about 75° C. with mixing for 15 minutes. The mixture was allowed to cool to about 57° C. and then transferred to a scraped surface heat exchanger and allowed to cool to about 32° C. with constant scraping of the bowl. The mixture was then blended further using a high shear immersion blender and packed off at 35° C. The product shortening had a soft texture.

TABLE 13

| Ingredient | Amount (weight %) |
|---|---|
| Canola oil | 22.5 |
| Admul ® MG 40-04K | 1.75 |
| Myvacet ® 5-07K | 50 |
| Myvacet ® 9-35 | 22.5 |
| Admul ® S 65K | 3.25 |

### EXAMPLE 14

This example illustrates an embodiment of a shortening composition of the present invention, wherein the shortening composition comprises acetylated monoglycerides, vegetable oil, vegetable hard stock, and monoglycerides. The ingredients were melted together at about 75° C. with mixing for 15 minutes. The mixture was allowed to cool to about 57° C. and then transferred to a scraped surface heat exchanger and allowed to cool to about 32° C. with constant scraping of the bowl. The mixture was then blended further using a high shear immersion blender and packed off at 35° C. The product shortening had a soft smooth texture.

TABLE 14

| Ingredient | Amount (weight %) |
|---|---|
| Canola oil | 22.5 |
| Palm stearine | 9 |
| Admul ® MG 40-04K | 2 |
| Myvacet ® 5-07K | 44 |
| Myvacet ® 9-35 | 22.5 |

### EXAMPLE 15

This example illustrates an embodiment of a shortening composition of the present invention, wherein the shortening composition comprises acetylated monoglycerides, vegetable oil, vegetable hard stock, and monoglycerides. The ingredients were melted together at about 75° C. with mixing for 15 minutes. The mixture was allowed to cool to about 57° C. and then transferred to a scraped surface heat exchanger and allowed to cool to about 32° C. with constant scraping of the bowl. The mixture was then blended further using a high shear immersion blender and packed off at 35° C. The product shortening had smooth texture.

TABLE 15

| Ingredient | Amount (weight %) |
|---|---|
| Canola oil | 22.5 |
| Palm stearine | 10 |
| Admul ® MG 40-04K | 2 |
| Myvacet ® 5-07K | 50 |
| Myvacet ® 9-35 | 15.5 |

### EXAMPLE 16

This example illustrates an embodiment of a shortening composition of the present invention, wherein the shortening composition comprises acetylated monoglycerides, vegetable oil, vegetable hard stock, and monoglycerides. The ingredients were melted together at about 75° C. with mixing for 15 minutes. The mixture was allowed to cool to about 57° C. and then transferred to a scraped surface heat exchanger and allowed to cool to about 32° C. with constant scraping of the bowl. The mixture was then blended further using a high shear immersion blender to 4 temperatures: 35, 38, 41, and 43° C. No significant difference was observed in product texture between the different temperatures. The product shortenings had a firm crumbly texture.

TABLE 16

| Ingredient | Amount (weight %) |
|---|---|
| Canola oil | 22.5 |
| Fully hydrogenated palm PO58 | 10 |
| Admul ® MG 40-04K | 2 |
| Myvacet ® 5-07K | 50 |
| Myvacet ® 9-35 | 15.5 |

### EXAMPLE 17

This example illustrates an embodiment of a shortening composition of the present invention, wherein the shortening composition comprises acetylated monoglycerides, vegetable oil, vegetable hard stock, and monoglycerides. The ingredients were melted together at about 75° C. with mixing for 15 minutes. The mixture was allowed to cool to about 57° C. and then transferred to a scraped surface heat exchanger and allowed to cool to about 32° C. with constant scraping of the bowl. The mixture was then blended further using a high shear immersion blender and packed off at 35° C.

TABLE 17

| Ingredient | Amount (weight %) |
|---|---|
| Canola oil | 22.5 |
| Palm stearine | 7.5 |
| Admul ® MG 40-04K | 2 |
| Myvacet ® 5-07K | 50 |
| Myvacet ® 9-35 | 18 |

### EXAMPLE 18

This example illustrates an embodiment of a shortening composition of the present invention, wherein the shortening composition comprises acetylated monoglycerides, vegetable oil, vegetable hard stock, and monoglycerides. The ingredients were melted together at about 75° C. with mixing for 15 minutes. The mixture was allowed to cool to about 57° C. and then transferred to a scraped surface heat exchanger and allowed to cool to about 32° C. with constant scraping of the bowl. The mixture was then blended further using a high shear immersion blender and packed off at 35° C. The product shortening had a slightly crumbly texture.

TABLE 18

| Ingredient | Amount (weight %) |
|---|---|
| Canola oil | 22.5 |
| Palm stearine Revel A | 5 |
| Admul ® MG 40-04K | 2 |
| Myvacet ® 5-07K | 50 |
| Myvacet ® 9-35 | 20.5 |

### EXAMPLE 19

This example illustrates an embodiment of a shortening composition of the present invention, wherein the shortening composition comprises acetylated monoglycerides, vegetable oil, vegetable hard stock, and monoglycerides. The ingredients were melted together at about 75° C. with mixing for 15 minutes. The mixture was allowed to cool to about 57° C. and then transferred to a scraped surface heat exchanger and allowed to cool to about 32° C. with constant scraping of the bowl. The mixture was then blended further using a high shear immersion blender and packed off at 35° C. The product shortening had a firm slightly crumbly texture.

TABLE 19

| Ingredient | Amount (weight %) |
|---|---|
| Canola oil | 22.5 |
| Myverol ® 18-06K | 5 |
| Palm stearine Revel ® A | 5 |
| Admul ® MG 40-04K | 2 |
| Myvacet ® 5-07K | 50 |
| Myvacet ® 9-35 | 15.5 |

Examples 20-26 are related to zero trans fat danish of the present invention. The danish are prepared using a dough of the present invention comprising the following ingredients: 344 g water, 283 g whole egg, 85 g high fructose corn syrup (HFCS), 30 g yeast, 35.3 g butter, 86 g of Myvatex® Sweet NT K, 17.7 g salt, 30.9 g non-fat dairy milk, 23 g 63 DE corn syrup, 58 g sugar, 5.4 g Biobake® SLP, 2.0 g Dorel® 8395, 1000 g patent flour, and 12 g of butter flavoring. To 1000 g of this dough was added 240 g of the trans fatty acid-free shortening of the present invention, as described in the Example.

The doughs are prepared by laminating the dough (3×3); retarding for 1 hour; and proofing for 40 minutes. The doughs are then baked for 14 minutes at 400° F.

### EXAMPLE 20

In accordance with the present invention, danish was prepared using the above general process and the shortening composition of Example 1.

### EXAMPLE 21

In accordance with the present invention, danish was prepared using the above general process and the shortening composition of Example 2.

### EXAMPLE 22

In accordance with the present invention, danish was prepared using the above general process the shortening composition of Example 3.

### EXAMPLE 23

In accordance with the present invention, danish was prepared using the above general process the shortening composition of Example 4.

### EXAMPLE 24

In accordance with the present invention, danish was prepared using the above general process the shortening composition of Example 5.

### EXAMPLE 25

In accordance with the present invention, danish was prepared using the above general process the shortening composition of Example 6.

### EXAMPLE 26

In accordance with the present invention, danish was prepared using the above general process the shortening composition of Example 8.

Examples 27-28 are related to zero trans fat croissant of the present invention. The croissant are prepared using a laminated dough of the present invention comprising the following ingredients: 600 g water, 33 g yeast, 25 g of Myvatex® Sweet NT, 15 g salt, 30 g nonfat dairy milk, 100 g sugar, 0.4 g BioBake® 2000, 1000 g flour, 2.0 g of Dorel® 8395. To 1000 g of this dough was added 300 g of the trans fatty acid-free shortening of the present invention, as described in the Example. The doughs are prepared by mixing the ingredients at 2° C., floor time for 20 minutes, laminating the dough (3×3), refrigerating the laminated dough for 4 hours,

### EXAMPLE 27

In accordance with the present invention, croissant was prepared using the above general process and the shortening composition of Example 8.

### EXAMPLE 28

In accordance with the -present invention, croissant was prepared using the above general process and the shortening composition of Example 12.

All references, including publications, patent applications, and patents, cited herein are hereby incorporated by reference to the same extent as if each reference were individually and specifically indicated to be incorporated by reference and were set forth in its entirety herein.

Preferred embodiments of this invention are described herein, including the best mode know to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as. Moreover, any combination of the above-described elements in all possible variations thereof is encompassed by the invention unless otherwise indicated herein or otherwise clearly contradicted by context.

1. A shortening composition comprising at least one partially acetylated monoglyceride, at least one fully acetylated monoglyceride, at least one mixed mono-diglyceride, and at least one vegetable oil, wherein the composition is free of trans fatty acids.

2. The shortening composition of claim 1 comprising at least one vegetable stock.

3. The shortening composition of claim 1 comprising one or more antioxidants.

4. The shortening composition of claim 1, wherein the composition is anhydrous.

5. A shortening composition comprising from about 5-70% by weight of at least one partially acetylated monoglyceride, from about 2-30% by weight of at least one fully acetylated monoglyceride, from about 2-30% by weight of at least one mixed mono-diglyceride, from about 15-90% by weight of at least one vegetable oil, from about 2-15% by weight of at least one vegetable stock, and optionally one or more antioxidants, wherein the composition is free of trans fatty acids.

6. The shortening composition of claim 5, wherein the partially acetylated monoglyceride, the fully acetylated monoglyceride, and the mixed mono-diglyceride are comprised of C₁₆-C₂₀ fatty acids, and mixtures thereof.

7. The shortening composition of claim 5, wherein the partially acetylated monoglyceride, the fully acetylated monoglyceride, and the mixed mono-diglyceride are comprised of fatty acids selected from the group consisting of linoleic, myristic, oleic, palmitic, stearic acid, and mixtures thereof.

8. The shortening composition of claim 5, wherein the vegetable oil is selected from the group consisting of canola oil, cottonseed oil, sunflower oil, safflower oil, corn oil, palm oil, soybean oil and mixtures thereof.

9. The shortening composition of claim 5, wherein the vegetable hard stock is a fractionated vegetable oil.

10. The shortening composition of claim 5, wherein the vegetable hard stock is a fully hydrogenated vegetable oil.

11. The shortening composition of claim 5, wherein the vegetable hard stock is selected from the group consisting of palm stearine, fully hydrogenated cottonseed oil, fully hydrogenated palm oil, fully hydrogenated canola oil.

12. The shortening composition of claim 5, wherein the antioxidant is selected from the group consisting of butylated hydroxyanisole, citric acid, ascorbic acid.

13. The shortening composition of claim 5, comprising a partially acetylated monoglyceride which has an hydroxyl value from about 100-200, a saponification value of about 250-325 mg KOH/g, an iodine value of about 0-10 g L/100 g, and a melting point of about 40-60° C.

14. The shortening composition of claim 5 comprising a fully acetylated monoglyceride which has an hydroxyl value from about 0-25, a saponification value of about 350-425 mg KOH/g, an iodine value of about 20-40 g L/100 g, and a melting point of about 10-25° C.

15. The shortening composition of claim 5 comprising a mixed mono-diglyceride which contains about 30-95% by weight monoglyceride, up to about 2% by weight free glycerol, which has an acid value of up to about 5 mg KOH/g, and an iodine value of up to about 5 g L/100 g.

16. A process for preparing the shortening composition of claim 5 comprising the steps of:
a) forming a mixture of the partially acetylated monoglyceride, the fully acetylated monoglyceride, the mixed mono-diglyceride, the vegetable oil, and vegetable hard stock;
b) melting the mixture with stirring for a period of time to obtain a clear homogenous melt;
c) cooling the melt under shear for a period of time to obtain a partially solidified mixture;
d) kneading the mixture for a period of time to obtain a smooth homogenous mixture which has a shiny appearance.

17. A laminated dough comprising the shortening composition of claim 5.

18. A laminated dough comprising from about 6-30% by weight of the shortening composition of claim 5.

19. A baked good prepared from the dough of claim 18.

20. The baked good of claim 19, wherein the baked good is selected from the group consisting of danish, napoleon, and croissant.

21. The baked good of claim 20, wherein the baked good is a danish.

22. The baked good of claim 20, wherein the baked good is a napoleon.

23. The baked good of claim 20, wherein the baked good is a croissant.
